(19) United States
(12) Patent Application Publication
(10) Pub. No.: US 2017/0226972 A1
(43) Pub. Date: Aug. 10, 2017

(54) INTAKE SENSOR

(71) Applicant: NGK Spark Plug Co., LTD., Nagoya (JP)

(72) Inventors: Masao TSUZUKI, Kakamigahara (JP); Kentaro MORI, Inuyama (JP); Hirotoshi YOSHIZAKI, Nagoya (JP); Keisuke YOKOI, Nagoya (JP); Ginjiro ITO, Nagoya (JP)

(73) Assignee: NGK Spark Plug Co., LTD., Nagoya (JP)

(21) Appl. No.: 15/426,604

(22) Filed: Feb. 7, 2017

(30) Foreign Application Priority Data
Feb. 10, 2016 (JP) 2016-023811
Sep. 30, 2016 (JP) 2016-193384

(51) Int. Cl. F02M 35/10; G01N 27/407; G01N 27/406

(52) U.S. Cl. CPC F02M 35/10393; F02M 35/10222; G01N 27/4067; G01N 27/4077; G01N 27/4073

(57) ABSTRACT

An intake sensor includes a detection element, a heater, a housing, and a protector. The protector has two or more tubular portions spaced from one another in the radial direction. Of any two adjacent tubular portions, a second tubular portion on the outer side has tubular walls present in the penetration direction of first through holes of a first tubular portion on the inner side. Second through holes of the second tubular portion have an area equal to or greater than that of the first through hole. When the intake sensor is disposed in a model gas mixture of butane and air having air-fuel ratio of about 13, pressure of about 0.11 MPa, temperature of about 20° C., and flow rate of about 0 m/sec, and the heater heats the solid electrolyte member to the target temperature, no combustion flame is visually recognized on the outer surface of the protector.

This application claims the benefit of Japanese Patent Applications No. 2016-023811, filed Feb. 10, 2016 and No. 2016-193384, filed Sep. 30, 2016, all of which are incorporated herein in their entireties by reference.

### FIELD OF THE INVENTION

The present invention relates to an intake sensor which is provided in an intake system of an internal combustion engine, the intake sensor including a detection element which is exposed to a gas-to-be-detected in order to detect a particular gas component contained in the gas. More particularly, the present invention relates to an intake sensor of such a type that has a protector for protecting the detection element from adhesion of water or the like.

### BACKGROUND OF THE INVENTION

There has conventionally been known a gas sensor which is attached to an exhaust pipe or the like of an automobile for use and which includes a detection element for detecting the concentration of a particular gas component (for example, NOx (nitrogen oxide), oxygen, etc.) contained in exhaust gas. In such a gas sensor, the sensor element includes a cell composed of an oxygen-ion-conductive solid electrolyte member and a pair of electrodes disposed on the solid electrolyte member, and the cell measures electromotive force generated in accordance with the concentration of oxygen in the gas-to-be-detected. Therefore, the detection element includes a heater for heating the solid electrolyte member to an activation temperature.

Meanwhile, a protector for covering the detection element is attached to the gas sensor in order to protect the detection element from adhesion of water or the like (see, for example Japanese Patent Application Laid-Open (kokai) No. 2011-112557).

Incidentally, a technique of introducing exhaust gas into an intake system (hereinafter referred to an “EGR system) is used so as to optimize combustion efficiency and reduce the amount of nitrogen oxide (NOx) discharged from an internal combustion engine. There has been known a technique of attaching a gas sensor to an intake recirculation gas passage of such an EGR system in order to detect the oxygen concentration of an intake recirculation gas which is a mixture of exhaust gas and intake gas (see, for example Japanese Patent Application Laid-Open (kokai) No. 2006-2761).

However, since a gas mixture including a combustible gas of gasoline or the like serving as a fuel flows through the intake system of the internal combustion engine, it is expected that the gas mixture comes into contact with the detection element heated by the heater and produces a flame. Since the detection element is covered with the protector as described above, even when the gas mixture produces a flame as a result of contact with the high-temperature detection element inside the protector, the flame does not ignite an external gas mixture outside the protector if the flame can be extinguished within the protector.

In view of the above, there has been proposed a combustible gas concentration sensor which is attached to the intake system of an internal combustion engine and in which the relation among the diameter of gas introduction holes of an outer protector, the thickness thereof, and the highest surface temperature is defined such that even when a flame is produced inside the protectors, the flame does not cause ignition and explosion of a combustible gas outside the sensor (see, for example Japanese Patent Application Laid-Open (kokai) No. 2001-108650).

### Problems to be Solved by the Invention

However, the combustible gas concentration sensor which is disclosed in Japanese Patent Application Laid-Open (kokai) No. 2001-108650 and in which the hole diameter of the outer protector is made smaller than the hole diameter of the inner protector so as to obtain a flame extinguishing function causes the following problem if such a gas concentration sensor is used in an EGR system. Namely, if foreign substances such as soot contained in EGR gas adhere to the holes of the outer protector, the holes are likely to be clogged when the diameter of the holes is small. This lowers the responsiveness of gas detection. Meanwhile, when the diameter of the holes of the outer protector is merely increased, the gas concentration sensor loses the flame extinguishing function and fails to have an explosion prevention function.

The present invention was made in view of the present situation, and an object of the invention is to provide an intake sensor having a protector which can prevent ignition of a fuel gas mixture even when the intake sensor is provided in an intake system of an internal combustion engine.

### SUMMARY OF THE INVENTION

### Means for Solving the Problems

An intake sensor of the present invention is provided in an intake system of an internal combustion engine and is used for an EGR system. The intake sensor comprises a detection element including at least one cell having an oxygen-ion conductive solid electrolyte member and a pair of electrodes disposed on the solid electrolyte member, the detection element extending in a direction of an axial line and having a detection portion on a forward end side so as to detect a particular gas component contained in a mixed gas; a heater that is configured to heat the solid electrolyte member to a target temperature; a housing which surrounds a circumference of the detection element such that the detection portion projects from a forward end of the housing; and a protector fixed to the housing and surrounding a circumference of the detection portion. The protector has a multi-wall structure having two or more tubular portions spaced from one another in a radial direction. Each of the tubular portions has a through hole penetrating therethrough, one of any two adjacent tubular portions which is located on an inner side in the radial direction is defined as a first tubular portion and the other of the two adjacent tubular portions which is located on an outer side in the radial direction is defined as a second tubular portion, and the second tubular portion has a tubular wall which is present in a penetration direction of a first through hole which is the through hole of the first tubular portion. A second through hole which is the through hole of the second tubular portion has an area equal to or greater than that of the first through hole. When the intake sensor is disposed in a model gas mixture of butane and air having an air-fuel ratio of 13, pressure of 0.11 MPa, temperature of 20° C., and flow rate of 0 m/sec, and the heater is energized to heat the solid electrolyte member to the target temperature, no combustion flame of the model gas mixture is visually recognized on the outer side of an outer surface of the protector.

In this intake sensor, the tubular wall of the second tubular portion is present in the penetration direction of the first through hole. The penetration direction of a hole is the axial direction of the hole (a direction perpendicular to the surface around the hole), and a combustion flame of a gas mixture propagates to the outside of the protector along the penetration direction. Accordingly, in the case where the tubular wall of the second tubular portion is present in the penetration direction of the first through hole through which the combustion flame propagates to the outside of the protector, even when the combustion flame propagates to the outside from the first through hole, the combustion flame hits the tubular wall of the second tubular portion, whereby the combustion flame is cooled and extinguished. Therefore, the combustion flame is prevented from spreading into an external space located outward of the outer surface of the protector and from igniting a gas mixture within the external space.

Further, the area of the second through hole is equal to or greater than that of the first through hole. Therefore, even when a foreign substance such as soot adheres to the outer surface of the second tubular portion, the entire second through hole is hardly closed, whereby deterioration of the responsiveness of the gas sensor can be prevented. Notably, in the case where a plurality of first through holes are present and a plurality of second through holes are present, the “area” of the first through hole means the area of a first through hole having the largest area, and the “area” of the second through hole means the area of a second through hole having the smallest area. Also, the area of a certain through hole means the area of that through hole as viewed (projected) in the penetration direction.

In the intake sensor of the present invention, preferably, the maximum spacing B between the second tubular portion and the first tubular portion in the radial direction is greater than 0 mm and not greater than 2.5 mm.

The smaller the spacing between the second tubular portion and the first tubular portion in the radial direction, the smaller the volume (gas capacity) inside the spacing and the greater the degree of contribution of the second tubular portion to cooling the gas (combustion flame). Therefore, it is possible to effectively stop spreading of the combustion flame and extinguish the combustion flame within the protector.

In the intake sensor of the present invention, preferably, the maximum thickness t of a portion of the second tubular portion which faces the first tubular portion is in a range of 0.3 mm to 1.0 mm.

Since the second tubular portion functions as a heat sink for cooling and extinguishing the combustion flame, it is considered that the greater the heat capacity (the thickness) of the second tubular portion, the better the results will be. However, it was found that the amount of heat of the combustion flame is not so large and the cooling performance of the surface of the second tubular portion is effective for extinguishing. Namely, the combustion flame cooling effect can be secured by setting the thickness t of the second tubular portion to 0.3 mm or grater. Meanwhile, the thicker the second tubular portion, the greater the amount of electric power consumed by the intake sensor. Also, in the case where the intake sensor is configured such that upper portions (rear ends) of the tubular portions are gastightly closed with a resin member, the risk that heat from the second tubular potion damages the resin member increases. Therefore, by setting the thickness t to 1.0 mm or less, it is possible to suppress consumption of electric power and damage to the resin member.

The intake sensor of the present invention may be configured such that the first tubular portion has a plurality of the first through holes, and one of the first through holes is a gas discharge hole formed in a forward end portion of the first tubular portion; the second tubular portion has a plurality of the second through holes, and a rear-end-side first through hole which is one of the first through holes but differs from the gas discharge hole is disposed rearward of a rear-end-side second through hole which is one of the second through holes and is located at the rearmost end; and the detection portion overlaps the rear-end-side first through holes in the direction of the axial line or located forward of the rear-end-side first through holes.

Since this intake sensor has an enhanced gas discharge performance, the flow speed of the gas mixture flowing inside the protector and coming into contact with the detection portion of the detection element increases. Therefore, the responsiveness of the sensor is enhanced. Meanwhile, since the rear-end-side first through hole is provided in the vicinity of the detection portion which is heated to a high temperature by the heater and first ignites the gas mixture, the ignited gas mixture is likely to vigorously spread outward through the rear-end-side first through hole and is likely to ignite a gas mixture outside the protector. Therefore, the present invention can be applied more effectively to the protector having such a structure.

In the intake sensor of the present invention, preferably, the minimum distance A between the rear-end-side first through hole and the rear-end-side second through hole in the direction of the axial line satisfies a relation of A/B≧1 and a relation of A≦30 mm.

In this intake sensor, the axial length (route) of the space in the radial spacing between the second tubular portion and the first tubular portion can be made greater than the maximum spacing B. Therefore, the combustion flame can be cooled more by the second tubular portion within the route. Also, since the minimum distance A is 30 mm or less, it is possible to prevent the minimum distance A from becoming excessively large, which would make it difficult to reduce the size of the sensor.

In the intake sensor, preferably, both the first tubular portion and the second tubular portion have their bottom walls on the forward end side in the direction of the axial line, the first tubular portion is accommodated in the second tubular portion, and the tubular wall of the second tubular portion and the tubular wall of the first tubular portion are located close to each other with a gap formed therebetween, or are in contact with each other, at a predetermined position in the direction of the axial line; the first tubular portion has a plurality of the first through holes, and one of the first through holes is a gas discharge hole formed in a forward end portion of the first tubular portion; the second tubular portion has a plurality of the second through holes, and a rear-end-side first through hole which is one of the first through holes but differs from the gas discharge hole is disposed rearward of a rear-end-side second through hole which is one of the second through holes and is located at the rearmost end; when a space surrounded by the second tubular portion and the first tubular portion on the rear end side of the predetermined position is defined as a first chamber, and a space surrounded by the second tubular portion and the first tubular portion on the forward end side of the predetermined position is defined as a second chamber, the rear-end-side first through hole and the rear-end-side second through hole face the first chamber, and the gas discharge hole and a forward-end-side second through hole which is one of the second through holes and is located forward of the rear-end-side second through hole face the second chamber; and a first-chamber-side flow channel coefficient Q1 expressed by a formula of (1/A1+1/A2)×L1 and a second-chamber-side flow channel coefficient Q2 expressed by a formula of (1/A3+1/A4)×L2 satisfy a relation of 0.1≦{Q1/(Q1+Q2)}≦0.9, where A1 is a total area of the rear-end-side first through hole, A2 is a total area of the rear-end-side second through hole, A3 is a total area of the gas discharge hole, A4 is a total area of the forward-end-side second through hole, L1 is the sum of a shortest distance L11 in the direction of the axial line between the centroid of the rear-end-side first through hole and the centroid of a gas introduction portion which is provided on the detection element for introducing the gas to the detection portion and a shortest distance L12 in the direction of the axial line between the centroid of the rear-end-side first through hole and the centroid of the rear-end-side second through holes, and L2 is the sum of a shortest distance L21 in the direction of the axial line between the centroid of the gas discharge hole and the centroid of the gas introduction portion and a shortest distance L22 in the direction of the axial line between the centroid of the gas discharge hole and the centroid of the forward-end-side second through hole.

In this intake sensor, the space between the first tubular portion and the second tubular portion is divided into two spaces; i.e., the first chamber and the second chamber. Therefore, for example, when a flame first blows into the first chamber from the rear-end-side first through hole on the first chamber side, the pressure within the first chamber increases, and the propagation of the flame toward the rear-end-side second through hole is restrained. Therefore, it is possible to prevent the flame from reaching the outside of the second tubular portion.

Further, the time required for the flame to pass through the first chamber and reach the outside of the second tubular portion can be expressed by a first-chamber-side flow channel coefficient Q1 which is the product of the resistance and distance of a flow channel passing through the rear-end-side first through hole and the rear-end-side second through hole. Similarly, the time required for the flame to pass through the second chamber and reach the outside of the second tubular portion can be expressed by a second-chamber-side flow channel coefficient Q2 which is determined in the same manner as in the case of the first-chamber-side flow channel coefficient Q1.

When the values of Q1 and Q2 differ greatly, a flame becomes likely to blow from one of the first chamber and the second chamber ahead of blowing from the other chamber, and an external gas mixture becomes more likely to be ignited. Therefore, the first-chamber-side flow channel coefficient Q1 and the second-chamber-side flow channel coefficient Q2 are determined to satisfy the relation of 0.1≦{Q1/(Q1+Q2)}≦0.9.

In the intake sensor of the present invention, preferably, an index Sc representing the size of the gap V and expressed by a formula of (SA2−SA1)/SA1 is 0.3 or less, where SA1 is the area of a region surrounded by an outer edge of the first tubular portion in a cross section which intersects the axial line at the predetermined position, and SA2 is the area of a region surrounded by an inner edge of the second tubular portion in the cross section.

When Sc≦0.3, the gap V produces a sufficiently large passage resistance, and the first chamber and the second chamber can be separated from each other without fail irrespective of presence of the gap V.

According to the present invention, there can be obtained an intake sensor having a protector which can prevent ignition of a fuel gas mixture even when the intake sensor is provided in an intake system of an internal combustion engine.

### BRIEF DESCRIPTION OF THE DRAWINGS

These and other features and advantages of the present invention will become more readily appreciated when considered in connection with the following detailed description and appended drawings, wherein like designations denote like elements in the various views, and wherein:

FIG. 1 is a half sectional view of an intake sensor according to an embodiment of the present invention.

FIG. 2 is a sectional view of a first tubular portion of the intake sensor.

FIG. 3 is a sectional view of a second tubular portion of the intake sensor.

FIG. 4 is a view used for describing a flow of a gas mixture within the intake sensor.

FIGS. 5A-5D are images showing a state in which a flame generated inside a protector is extinguished.

FIG. 6 is a reference image showing a state in which a flame generated inside the protector spreads externally.

FIG. 7 is a partial cross-sectional view showing another protector of the embodiment of the present invention.

FIG. 8 is a partial cross-sectional view showing still another protector of the embodiment of the present invention.

FIG. 9 is a chart used for describing the definition of first-chamber-side and second-chamber-side flow channel coefficients in the intake sensor of FIG. 1.

FIG. 10 is a graph showing the results of an evaluation test in which the intake sensor was checked for production of flame in a model gas mixture while the first-chamber-side and second-chamber-side flow channel coefficients of the protector were changed.

### DETAILED DESCRIPTION OF THE INVENTION

### Modes for Carrying Out the Invention

An embodiment of the present invention will next be described with reference to the drawings.

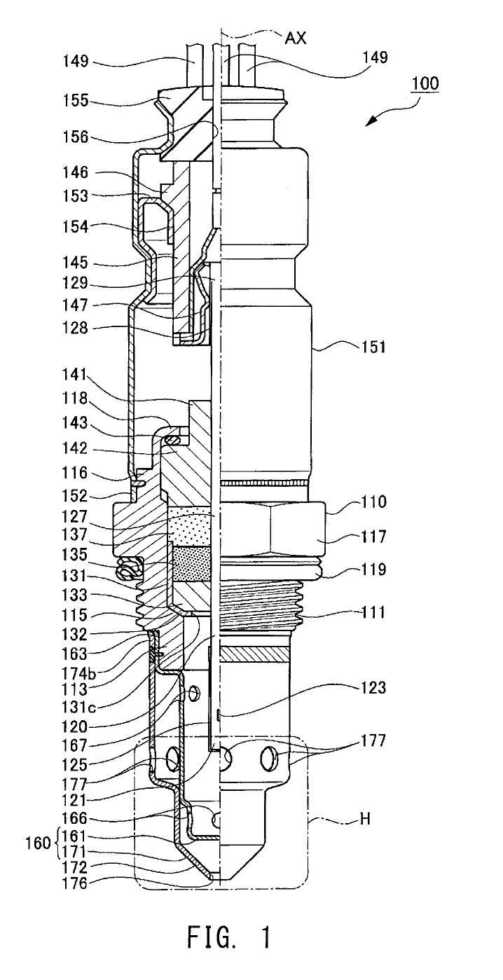

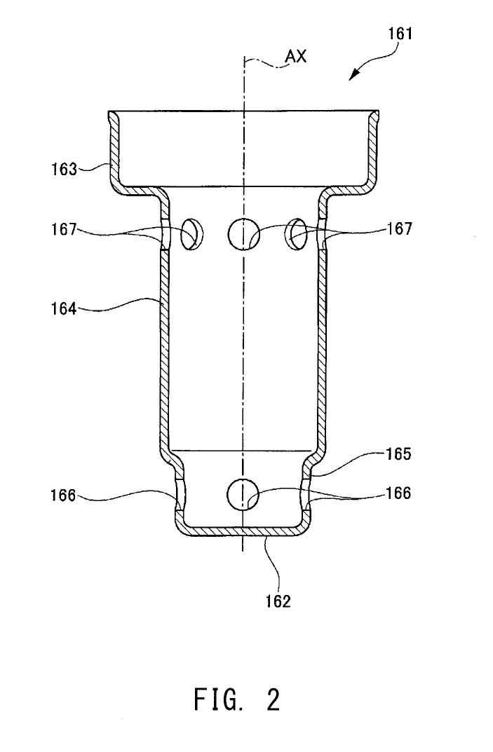

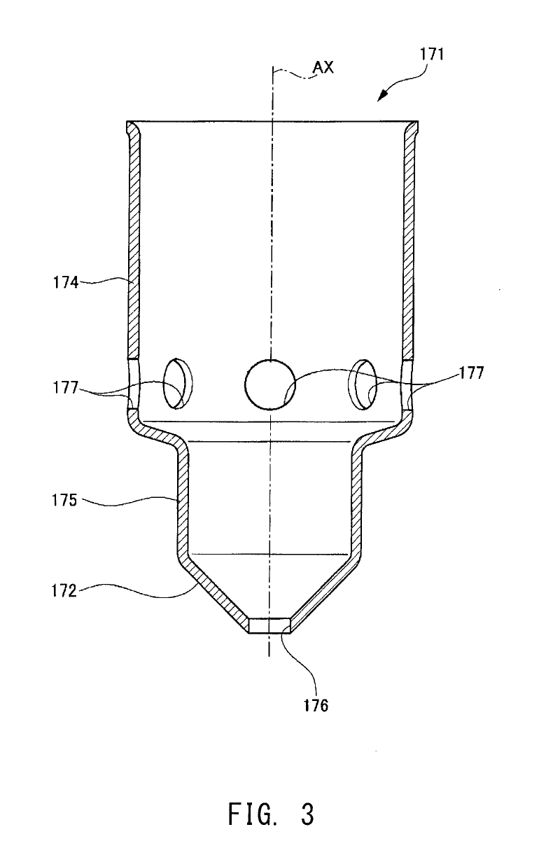

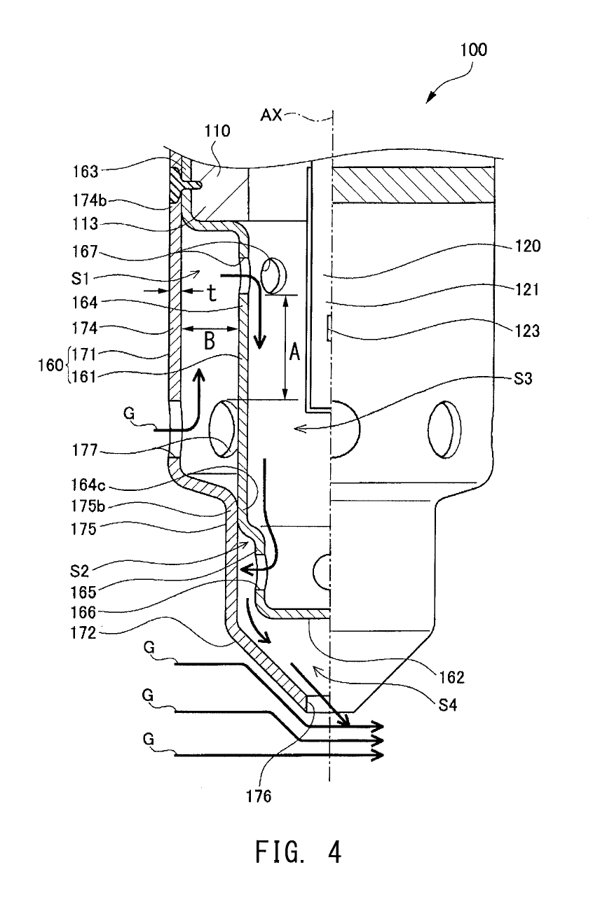

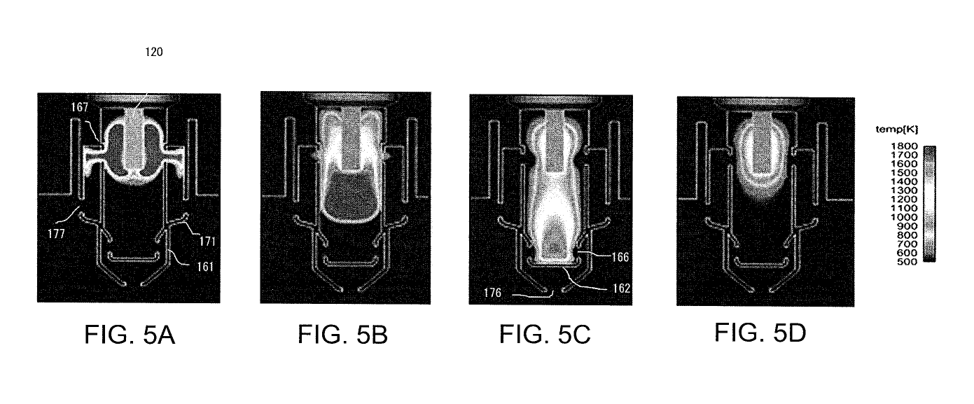

FIG. 1 is a half sectional view of an intake sensor 100 of the embodiment of the present invention. FIG. 2 is a sectional view of a first tubular portion 161 of the intake sensor 100. FIG. 3 is a sectional view of a second tubular portion 171 of the intake sensor 100. FIG. 4 is an enlarged view of a forward end portion (a portion including a region H of FIG. 1) of the intake sensor 100 which is attached to an intake system (an intake manifold, etc.) of an unillustrated automobile such that the forward end portion of the intake sensor 100 is located within the intake system. FIG. 4 is used for describing the flow of a gas mixture (gas-to-be-detected) G which contains gasoline serving as a fuel. FIGS. 5A-5D are images showing a state in which a flame generated inside a protector 160 is extinguished.

Notably, in FIGS. 1 to 5D, the lower side is an axially forward end side (hereinafter also referred to as the forward end side for simplicity), and the upper side is an axially rear end side (hereinafter also referred to as the rear end side for simplicity). Also, in FIG. 4, the left side is the upstream side of the intake system through which the gas mixture G flows, and the right side is the downstream side (the engine side) of the intake system.

The intake sensor 100 is a so-called full range air/fuel ratio sensor which is attached to the intake system of an unillustrated automobile and which holds therein a detection element 120. A detection portion 121 of the detection element 120 is exposed to the gas mixture (gas-to-be-detected) which flows through the intake system so as to detect the air/fuel ratio of the gas mixture from the concentration of oxygen (particular gas component) contained in the gas mixture

As shown in FIG. 1, this intake sensor 100 is mainly composed of a tubular metallic shell (housing) 110 extending in an axial direction (the direction along an axis AX, the vertical direction in FIG. 1); the plate-shaped detection element 120 held inside the metallic shell 110; an outer cylinder 151 fixedly provided on the rear end side of the metallic shell 110; and a double-wall protector 160 which is fixedly provided on the forward end side of the metallic shell 110 and which is composed of a first tubular portion 161 and a second tubular portion 171.

The detection element 120 has a plate-like shape (strip-like shape) extending in the axial direction, and a forward end portion of the detection element 120 is the detection portion 121 for detecting the oxygen gas component contained in the gas mixture. This detection element 120 has a known structure and is formed by bonding together for unification a plate-shaped gas detecting body for detecting oxygen concentration and a plate-shaped heater (not illustrated) for heating the gas detecting body for quick activation thereof. The gas detecting body is composed of an oxygen-ion conductive solid electrolyte member which predominantly contains zirconia, and a pair of electrodes (detection and reference electrodes) which predominantly contains platinum. The pair of electrodes are disposed on the detection portion 121.

The detection portion 121 has a gas introduction portion 123 for introducing the gas mixture into the interior of the element. This gas introduction portion 123 is formed of a porous material and has a rectangular shape in a planar view. In order to protect the detection electrode from poisoning by oil or the like contained in the gas mixture, a protection layer 125 is provided on the detection portion 121 such that the protection layer 125 covers the outer surface of the detection portion 121. Also, five electrode pads 128 (one of which is shown in FIG. 1) for allowing external connection with the electrodes of the gas detecting body and the heater are formed on a rear end portion 129 of the detection element 120.

A bottomed tubular metal cup 131 is disposed at a position slightly deviated forward from the center of a trunk portion 127 of the detection element 120 in such a manner that the detection element 120 is inserted through the interior of the metal cup 131 with the detection portion 121 projecting from an opening 131c formed in the bottom of the metal cup 131. The metal cup 131 is a member for holding the detection element 120 in the metallic shell 110. A forward-end peripheral edge portion 132 of the metal cup 131 is tapered such that the diameter of the metal cup 131 decreases toward the forward end thereof.

The metal cup 131 contains a ceramic ring 133 made of alumina and a first talc ring 135 formed by compacting a talc powder, in such a manner that the detection element 120 is inserted through the ceramic ring 133 and through the first talc ring 135. The first talc ring 135 is crushed within the metal cup 131 so as to tightly fill an associated space, thereby holding the detection element 120 in position in the metal cup 131.

The detection element 120 united with the metal cup 131 is held by the tubular metallic shell 110 such that its radial circumference is surrounded by the metallic shell 110. The metallic shell 110 is adapted to fixedly attach the intake sensor 100 to the intake system of the automobile. The metallic shell 110 is formed of SUS430. An external thread portion 111 for attachment to the intake system is formed on the forward end side of the outer circumference of the metallic shell 110. The metallic shell 110 has an annular forward end fixing portion 113 which is projectingly formed on the forward end side of the external thread portion 111 and to which the protector 160 to be described later is fixed.

The metallic shell 110 also has a tool engagement portion 117 which is formed at the center of the outer circumference of the metallic shell 110 and with which a mounting tool is engaged. In order to prevent leakage of gas when the intake sensor 100 is attached to the intake system, a gasket 119 is fitted to a portion of the metallic shell 110 between the tool engagement portion 117 and the external thread portion 111. The metallic shell 110 further has a rear end fixing portion 116 which is formed on the rear end side of the tool engagement portion 117 and to which the outer cylinder 151 to be described later is fixed. The metallic shell 110 further has a crimp portion 118 which is formed on the rear end side of the rear end fixing portion 116 and which is adapted to crimp-hold the detection element 120 in the metallic shell 110. Notably, in general, the size of the tool engagement portion 117 of the metallic shell 110 is about M18 to M20.

The metallic shell 110 has a stepped portion 115 which is formed on the forward end side of the inner circumference of the metallic shell 110 and which is tapered such that its diameter decreases toward the forward end side. The tapered front-end peripheral edge portion 132 of the metal cup 131 which holds the detection element 120 is engaged with the stepped portion 115.

Furthermore, a second talc ring 137 is disposed in the metallic shell 110 to be located on the rear end side of the metal cup 131 in such a state that the detection element 120 is inserted through the second talc ring 137. A tubular sleeve 141 is fitted into the metallic shell 110 in such a manner as to press the second talc ring 137 from the rear end side of the second talc ring 137. The sleeve 141 has a step-like shoulder portion 142. An annular crimp packing 143 is disposed on the shoulder portion 142. The crimp portion 118 of the metallic shell 110 is crimped in such a manner as to press the shoulder portion 142 of the sleeve 141 toward the forward end side via the crimp packing 143.

Being pressed by the sleeve 141, the second talc ring 137 is crushed within the metallic shell 110, thereby tightly filling an associated space. By means of the second talc ring 137 and the first talc ring 135, which is previously placed in the metal cup 131, the metal cup 131 and the detection element 120 are held in position in the metallic shell 110. The crimp packing 143 disposed between the crimp portion 118 and the shoulder portion 142 of the sleeve 141 maintains the airtightness of the interior of the metallic shell 110, to thereby prevent leakage of combustion gas.

A rear end portion 129 of the detection element 120 projects toward the rear end side beyond the crimp portion 118, which is the rear end portion of the metallic shell 110. The rear end portion 129 is covered with a tubular separator 145 formed from an electrically insulative ceramic. The separator 145 internally holds five connection terminals 147 (one of which is shown in FIG. 1) electrically connected to the five electrode pads 128 formed on the rear end portion 129 of the detection element 120. Also, the separator 145 accommodates connection portions between the connection terminals 147 and corresponding five lead wires 149 (three of which are shown in FIG. 1), which extend to the exterior of the intake sensor 100, while insulating them from one another.

The tubular outer cylinder 151 is disposed in such a manner as to surround the circumference of the separator 145. The outer cylinder 151 is made of stainless steel (SUS304 in the present embodiment). A forward end opening portion 152 of the outer cylinder 151 is disposed on the radially outer side of the rear end fixing portion 116 of the metallic shell 110. The forward end opening portion 152 is crimped radially inward, and laser welding is performed on the forward end opening portion 152 along the entire outer circumference thereof, whereby the forward end opening portion 152 is connected to the rear end fixing portion 116.

A tubular metal holder 153 is disposed in the gap between the outer cylinder 151 and the separator 145. The metal holder 153 has a support portion 154, which is formed by inwardly bending a rear end of the metal holder 153. The separator 145 is inserted through the metal holder 153 such that a flange portion 146 formed on the outer circumference of a rear end portion of the separator 145 is engaged with the support portion 154, whereby the separator 145 is supported by the support portion 154. In this condition, a portion of the outer cylinder 151 where the metal holder 153 is disposed is crimped radially inward, whereby the metal holder 153 which supports the separator 145 is fixed to the outer cylinder 151.

A grommet 155 made of fluorine-containing rubber is fitted into a rear end opening of the outer cylinder 151. The grommet 155 has five insertion holes 156 (one of which is shown in FIG. 1). The five lead wires 149 extending outwardly from the separator 145 are airtightly inserted through the respective insertion holes 156. In this condition, while the grommet 155 presses the separator 145 toward the forward end side, a portion of the outer cylinder 151 which corresponds to the grommet 155 is crimped radially inward, whereby the grommet 155 is fixed to the outer cylinder 151.

The detection portion 121 of the detection element 120 held by the metallic shell 110 projects from the forward end fixing portion 113, which is a forward end portion of the metallic shell 110. The protector 160 is fitted to the forward end fixing portion 113 so as to protect the detection portion 121 of the detection element 110 from fouling with oil originating from blowby gas and from breakage caused by adhesion of water. The protector 160 is fixed to the forward end fixing portion 113 by laser welding. This protector 160 includes a first tubular portion 161 having the form of a tube with a bottom, and a second tubular portion 171 which is located on the outer side of the first tubular portion 161 and accommodates the first tubular portion 161 (see FIGS. 1 to 4).

As shown in FIG. 4, the first tubular portion 161 is fixed to the metallic shell 110 in a state in which the detection portion 121 of the detection element 120 is disposed in the internal space S3 of the first tubular portion 161. As shown in FIGS. 1, 2, and 4, the first tubular portion 161 has a rear end portion 163; a first inner wall 164 located on the axially forward end side (the lower side in FIGS. 1, 2, and 4) of the rear end portion 163; a second inner wall 165 located on the axially forward end side of the first inner wall 164, and a disk-like inner bottom wall 162 which closes the forward end of the second inner wall 165.

The first inner wall 164 has a cylindrical tubular shape and has rear-end-side first through holes 167 which penetrate the first inner wall 164. Notably, in the present embodiment, eight rear-end-side first through holes 167 having the same shape (same dimension) are formed at equal intervals in the circumferential direction. All the eight rear-end-side first through holes 167 are located on the axially rear end side (the upper side in FIGS. 1 and 4) in relation to the detection portion 121 of the detection element 120.

The second inner wall 165 has a cylindrical tubular shape, is smaller in diameter than the first inner wall 164, and has forward-end-side first through holes 166 which penetrate the second inner wall 165. Notably, in the present embodiment, four forward-end-side first through holes 166 are formed at equal intervals in the circumferential direction. All the four forward-end-side first through holes 166 are located on the axially forward end side (the lower side in FIGS. 1 and 4) in relation to the detection portion 121 of the detection element 120.

The forward-end-side first through holes 166 and the rear-end-side first through holes 167 collectively correspond to the “first through hole” of the claims.

Notably, although the inner diameters of the first inner wall 164 and the second inner wall 165 are smaller than the outer diameter of the forward end fixing portion 113 of the metallic shell 110, the rear end portion 163 has an increased diameter such that the rear end portion 163 is located on the outer side of the forward end fixing portion 113.

The second tubular portion 171 is fixed to the metallic shell 110 in a state in which the second tubular portion 171 accommodates the first tubular portion 161 therein such that a radial gap is provided therebetween. The second tubular portion 171 has a first outer wall 174; a second outer wall 175 located on the axially forward end side of the first outer wall 174, and a taper wall 172 located on the axially forward end side of the second outer wall 175 (see FIGS. 1, 3, and 4).

The first outer wall 174 has a cylindrical tubular shape, and surrounds the circumference of the first inner wall 164 while forming a tubular first space S1 in cooperation with the first inner wall 164 of the first tubular portion 161. Further, the first outer wall 174 has rear-end-side second through holes 177 which penetrate the first outer wall 174 and are located on the axially forward end side in relation to the rear-end-side first through holes 167 of the first tubular portion 161 (see FIGS. 1 and 4). Notably, in the present embodiment, eight rear-end-side second through holes 177 having the same shape (same dimension) are formed at equal intervals in the circumferential direction. All the eight rear-end-side second through holes 177 are located on the axially forward end side in relation to the rear-end-side first through holes 167 of the first tubular portion 161.

The second outer wall 175 has a cylindrical tubular shape, and has an inner diameter smaller than the inner diameter of the first outer wall 174 and larger than the outer diameter of the first inner wall 164. Further, the second outer wall 175 surrounds the circumference of the second inner wall 165 while forming a tubular second space S2 in cooperation with the second inner wall 165. The second outer wall 175 extends to a point on the axially forward end side of the inner bottom wall 162 of the first tubular portion 161.

In particular, in the present embodiment, the second outer wall 175 is connected at its rear end portion 175b to a forward end portion 164c of the first inner wall 164 in an airtight manner (in a state in which gas cannot flows through the connected portion). Specifically, the rear end portion 175b of the second outer wall 175 and the forward end portion 164c of the first inner wall 164 are airtightly connected (fitted) together over the entire circumference around the axis AX by means of press-fitting the forward end portion 164c of the first inner wall 164 into the rear end portion 175b of the second outer wall 175.

The taper wall 172 has the shape of a tapered tube (truncated conical tube) whose diameter decreases toward the axially forward end side. This taper wall 172 has a forward-end-side second through hole 176, which is a forward end opening of the second tubular portion 171. In particular, in the present embodiment, the entirety of the taper wall 172 is disposed on the axially forward end side in relation to the inner bottom wall 162 of the first tubular portion 161.

The forward-end-side second through hole 176 and the rear-end-side second through holes 177 collectively correspond to the “second through hole” of the claims.

The rear end portion 174b of the first outer wall 174 of the second tubular portion 171 is disposed on the outer side of the rear end portion 163 of the first tubular portion 161. Laser welding is performed along the entire outer circumference of the rear end portion 174b of the second tubular portion 171 so as to fix (weld) the rear end portion 174b of the second tubular portion 171, together with the rear end portion 163 of the first tubular portion 161, to the forward end fixing portion 113 of the metallic shell 110.

In the intake sensor 100 of the present embodiment, the gas mixture (gas-to-be-detected) G within the intake system flows through the interior of the protector 160 (the first tubular portion 161 and the second tubular portion 171) along the following route.

Specifically, as shown in FIG. 4, the gas mixture G having flowed through the intake system from the upstream side thereof (the left side in FIG. 4) toward the intake sensor 100 is introduced into the first space S1 within the protector 160 (the space between the first outer wall 174 and the first inner wall 164) through the rear-end-side second through holes 177 of the second tubular portion 171 (outer gas introduction holes).

The gas mixture G then flows within the first space S1 toward the axially rear end side (the upper side in FIG. 4), and is introduced into the internal space S3 of the first tubular portion 161 through the rear-end-side first through holes 167 of the first tubular portion 161 (inner gas introduction holes). After that, the gas mixture G flows within the internal space S3 toward the axially forward end side (the lower side in FIG. 4), is discharged to the outside of the first tubular portion 161 through the forward-end-side first through holes 166 of the first tubular portion 161 (inner gas discharge holes, the “gas discharge hole” of the claims), and is introduced into the second space S2 (the space between the second outer wall 175 and the second inner wall 165). After being introduced into an in-taper space S4 surrounded by the taper wall 172 of the second tubular portion 171, the gas mixture G is discharged to the outside of the protector 160 through the forward-end-side second through hole 176 of the second tubular portion 171 (outer gas discharge hole).

Notably, the rear-end-side first through holes 167 of the first tubular portion 161 are located on the axially rear end side in relation to the detection portion 121 of the detection element 120, and the forward-end-side first through holes 166 are located on the axially forward end side in relation to the detection portion 121. Therefore, a portion of the gas mixture G introduced into the internal space S3 through the rear-end-side first through holes 167 is led to the gas introduction portion 123 of the detection portion 121 in the course of flowing within the internal space S3 toward the axially forward end side and being discharged to the outside of the first tubular portion 161 through the forward-end-side first through holes 166.

Further, in the intake sensor 100 of the present embodiment, the gas mixture G introduced from the outside into the interior of the second tubular portion 171 through the rear-end-side second through holes 177 of the second tubular portion 171 passes through the rear-end-side first through holes 167 of the first tubular portion 161, then flows into the internal space S3. After that, the gas mixture G flows toward the axially forward end side (the lower side in FIG. 4) within the internal space S3, is discharged to the outside of the first tubular portion 161 through the forward-end-side first through holes 166 of the first tubular portion 161, and is then discharged to the outside of the protector 160 through the forward-end-side second through hole 176 of the second tubular portion 171.

Next, the action of extinguishing the combustion flame of the gas mixture G (preventing explosion) by the protector 160, which is the feature of the present invention, will be described with reference to FIGS. 5A-5D.

FIGS. 5A-5D are images showing the results of a simulation in which the shape of the protector 160 of the intake sensor 100 of FIGS. 1 to 4 and its vicinity was reproduced and a gas mixture G having come into contact with the detection element 120 was caused to ignite within a protector 160. Notably, the present simulation was performed through use of a combustion/fluid analysis program for engines (CONVERGE (registered trademark)).

When the detection element 120 is heated to, for example, about 800° C. by the heater, the gas mixture G comes into contact with the detection element 120 and produces a combustion flame within the protector 160. The combustion flame spreads toward the outside through the rear-end-side first through holes 167 of the first tubular portion 161 closest to the detection element 120 and enters the first space S1 between the first tubular portion 161 and the second tubular portion 171 (FIG. 5A). The combustion flame hits the inner surface of the first outer wall 174 of the second tubular portion 171 to thereby be cooled and spreads toward the forward end of the first space S1. However, the combustion flame stops before reaching the rear-end-side second through holes 177.

Although the combustion flame within the first tubular portion 161 also spreads toward the forward end of the first tubular portion 161, the combustion flame within the first space S1 shrinks (FIG. 5B).

The combustion flame having spread toward the forward end of the first tubular portion 161 hits the inner bottom wall 162 of the first tubular portion 161 to thereby be cooled, and stopes without propagating to the outside through the forward-end-side first through holes 166 (FIG. 5C).

Finally, the combustion flame within the first tubular portion 161 shrinks and disappears quickly (FIG. 5D).

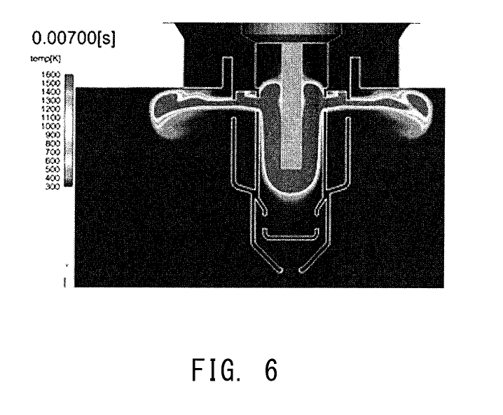

As shown by the results of the present simulation, when the detection element 120 is heated to, for example, 800° C., the gas mixture G ignites within the protector 160. Therefore, it is apparent that if the protector 160 is not present, the gas mixture G having come into contact with the detection element 120 ignites and produces a spreading flame in the measurement atmosphere. It is known that the control temperature of a typical detection element including a solid electrolyte member is about 600 to 900° C. Accordingly, at the target temperature of the solid electrolyte member realized by heating by the heater, the gas mixture ignites if no protector is provided. In the case were the through holes of an inner tubular portion of a double-wall protector overlap the through holes of an outer tubular portion of the double-wall protector unlike the protector of the present invention, as shown in FIG. 6, a flame generated inside the protector spreads to the outside of the protector.

The tubular wall of the second tubular portion is present in the penetration directions of the first through holes 166 and 167. The penetration direction of a hole is the axial direction of the hole (a direction perpendicular to the surface around the hole), and the combustion flame propagates to the outside of the protector 160 along the penetration direction. Accordingly, in the case where the tubular wall of the second tubular portion is present in the penetration directions of the first through holes 166 and 167 through which the combustion flame propagates to the outside of the protector 160, even when the combustion flame propagates to the outside from the first through holes 166 and 167, the combustion flame hits the tubular wall of the second tubular portion, whereby the combustion flame is cooled and extinguished. Therefore, the combustion flame is prevented from spreading into an external space located outward of the outer surface of the protector 160 and from igniting a gas mixture within the external space.

Although the penetration directions of the first through holes 166 and 167 are radial directions, in the case where a first through hole is provided in, for example, the inner bottom wall 162, the penetration direction of the first through hole coincides with the direction of the axial line AX.

The expression “the tubular wall of the second tubular portion is present in the penetration directions of the first through holes 166 and 167” means that the tubular wall of the second tubular portion is present in regions which are bounded by imaginary hollow cylinders formed by extending the outlines (contours) of the first through holes 166 and 167 along the penetration directions thereof. For example, as shown in FIG. 4, the “second outer wall 175” is present as a tubular wall in the penetration directions of the first through holes 166, and the “first outer wall 174” is present as a tubular wall in the penetration directions of the first through holes 167.

Notably, in the present embodiment, the expression “the tubular wall of the second tubular portion is present in the penetration directions of the first through holes 166 and 167” also means that the second through holes 176 and 177 do not overlap the first through holes 166 and 167 in the penetration directions of the first through holes 166 and 167. If the first tubular portion 161 is exposed from the second tubular portion 171 in a certain region, in that region, despite that “the tubular wall of the second tubular portion is not present in the penetration directions of the first through holes,” the second through holes of the second tubular portion 171 are not present. Therefore, the second through holes do not overlap the first through holes. In order to distinguish such a case from the above-described case, the expression “the tubular wall is present” is used.

As a test condition showing that a combustion flame does not spread into a space outside the outer surface of the protector 160 and does not ignite an external gas mixture, there was set a condition that a combustion flame of the model gas mixture is not visually recognized on the outer side of the outer surface of the protector 160 when the intake sensor 100 is disposed in a model gas mixture described below and the heater is energized.

The “outer surface of the protector 160” refers to the outermost surface of the protector 160. In the example shown in FIG. 4, the outer surface of the second tubular portion 171 which is located on the outermost side of the protector 160 is the outer surface of the protector 160. The judgement as to whether or not “a combustion flame of the model gas mixture is visually recognized” can be made easily by judging whether or not a flame (flash) is present on the outer side of the outer surface of the protector 160 in an image of the protector 160 of the intake sensor 100 disposed in the model gas mixture (or judging whether or not a flame (flash) can be seen on the outer side of the outer surface of the protector 160 by means of visual observation). Ideally, the expression “is not visually recognized” means that “combustion flame is not visually recognized” over a long period of time during which the intake sensor 100 operates. However, in actuality, it is sufficient to confirm that “combustion flame is not visually recognized” through a continuous test performed for about 1 minute. This is because when no explosion occurs in the continuous test, as a result of a mild combustion reaction, oxygen and the fuel in the gas mixture change to water and carbon dioxide with depletion of the fuel, and no explosion occurs after that.

As the model gas mixture, there is used a mixture of butane and air whose air-fuel ratio (A/F) is 13 (rich atmosphere), whose pressure is 0.11 MPa, whose temperature is 20° C., and whose flow rate is 0 m/sec. For example, the test conditions are as follows.

The above-mentioned model gas mixture is manufactured in advance by, for example, a process described below. First, a gas mixture chamber is evacuated, butane is introduced into the chamber, and the pressure within the chamber is measured. Subsequently, air is introduced into this gas mixture chamber, and the pressure within the chamber is measured. Through calculation based on the measured pressure and the pressure of butane, the amounts of butane and air introduced into the chamber are adjusted such that the air-fuel ratio becomes 13. Subsequently, the gas mixture is stirred thoroughly through use of a magnetic stirrer or the like.

Next, the intake sensor 100 is disposed in a test chamber, and the chamber is evacuated. A valve provided between the test chamber and the gas mixture chamber is opened so as to introduce the model gas mixture into the test chamber at a predetermined pressure and a predetermined temperature. Subsequently, the valve provided between the test chamber and the gas mixture chamber is closed, and the heater of the intake sensor 100 is energized so as to heat the detection element 120 to the target temperature (equal to or higher than the activation temperature of the detection element).

In the heated state, the interior of the test chamber is videoed through a window of the chamber and a judgement as to whether or not a flame has been produced is made by judging whether or not a flash is produced within the chamber. At the same time, the pressure within the chamber is monitored, and when the pressure changes, it is considered that a flame has been produced. This test is continued for one minute, and the judgement as to whether or not a flame has been produced is finally made after that.

Incidentally, as shown in FIG. 5A, the combustion flame propagating into the first space S1 through the rear-end-side first through holes 167 hits the inner surface of the second tubular portion 171 to thereby been cooled, and stops. At that time, the smaller the volume (gas capacity) of the first space S1, the greater the degree of contribution of the second tubular portion 171 to cooling the gas (combustion flame) to thereby effectively stop spreading of the combustion flame and extinguish the combustion flame within the protector 160.

In view of the above, it is preferred that the maximum spacing B in the radial direction between the second tubular portion 171 and the first tubular portion 161 shown in FIG. 4 be greater than 0 mm and not greater than 2.5 mm.

Since the second tubular portion 171 functions as a heat sink for cooling and extinguishing the combustion flame, it is considered that the greater the heat capacity (the thickness) of the second tubular portion 171, the better the results will be. However, it was found that the amount of heat of the combustion flame is not so large and the cooling performance of the surface of the second tubular portion 171 is effective for extinguishing. Also, when the thickness of the second tubular portion 171 increases, the responsiveness of the sensor deteriorates.

Namely, when the thickness of the second tubular portion 171 is increased excessively, the cooling effect saturates and the responsiveness of the sensor deteriorates. Therefore, it is preferred that the maximum thickness t of a portion of the second tubular portion 171 which faces the first tubular portion 161 fall in a range of 0.3 mm to 1.0 mm.

Similarly, it is preferred that the maximum thickness of a portion of the first tubular portion 161 which faces the second tubular portion 171 be 0.4 mm or less.

From the viewpoint of improving the responsiveness of the sensor, the rear-end-side first through holes 167 are preferably provided at a position where the rear-end-side first through holes 167 overlap at least a portion of the detection portion 121 in the direction of the axial line AX and are provided on the rear end side of the rear-end-side second through holes 177. This layout increases the gas discharge performance of the protector 160 and increases the flow speed of the gas mixture G flowing inside the protector 160 and coming into contact with the detection portion 121 of the detection element 120. Therefore, the responsiveness of the sensor is enhanced.

However, in this case, the rear-end-side first through holes 167 are provided in the vicinity of the detection portion 121 which is heated to a high temperature by the heater and first ignites the gas mixture G. Therefore, the ignited gas mixture G is likely to vigorously spread outward through the rear-end-side first through holes 167 and likely to ignite a gas mixture outside the protector 160. Therefore, the present invention can be applied more effectively to the protector 160 having such a structure.

Notably, the combustion flame spreading from the rear-end-side first through holes 167 toward the forward end side of the first space S1 also hits the inner surface of the second tubular portion 171 to thereby be cooled. Therefore, the greater the length (route) (in the direction of the axial line AX) of the first space S1 extending from the rear-end-side first through holes 167 to the rear-end-side second through holes 177, the greeter the degree to which the combustion flame is cooled and extinguished by the inner surface of the second tubular portion 171.

In view of this, it is preferred that a relation A/B≧1 be satisfied, where A is the minimum distance (in the direction of the axial line AX) between the rear-end-side first through holes 167 and the rear-end-side second through holes 177 shown in FIG. 4. As a result, the length (route) of the first space S1 in the direction of the axial line AX can be made greater than the maximum spacing B. Therefore, the combustion flame can be cooled more by the second tubular portion 171 within the route. However, when the minimum distance A is excessively large, the sensor cannot be made compact. Therefore, it is preferred that the minimum distance A be 30 mm or less.

Although the present invention has been described on the basis of an embodiment thereof, the present invention is not limited to the embodiment. Needless to say, the present invention may be implemented while being properly modified without departing from the scope of the invention.

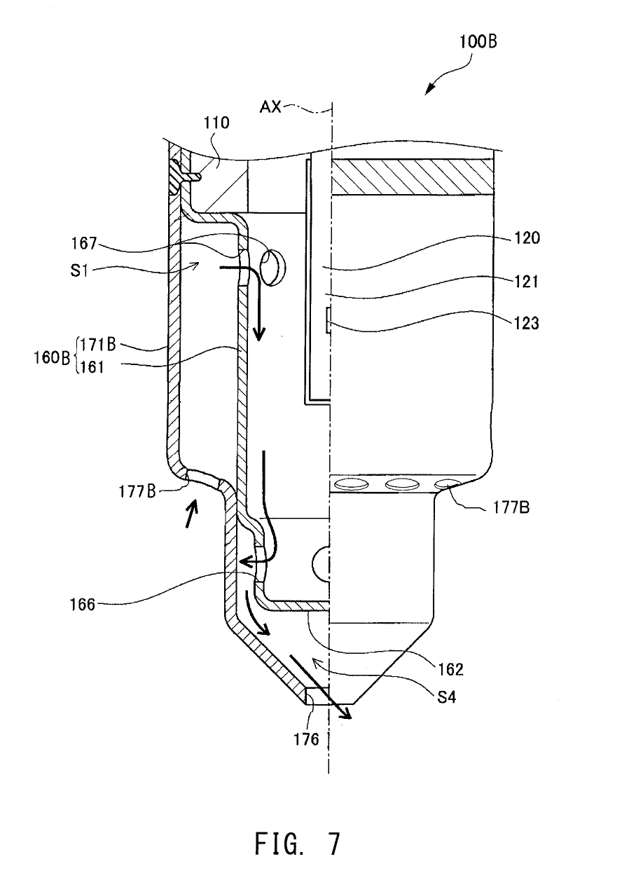

For example, in the above-described embodiment, the penetration directions of the second through holes 176 and 177 and the first through holes 166 and 167 are parallel to or orthogonal to the direction of the axial line AX. However, as shown in FIG. 7, the penetration directions of the rear-end-side second through holes 177 may be oblique to the direction of the axial line AX.

Notably, an intake sensor 100B of FIG. 7 is identical to the intake sensor 100 except for the shapes of a protector 160B and a second tubular portion 171B. Therefore, portions identical with those of the intake sensor 100 are denoted by the same reference numerals and their descriptions are omitted.

In the case of this protector 160B, a diameter decreasing portion of the second tubular portion 171B whose diameter decreases from the first outer wall 174 toward the second outer wall 175 has a plurality of rear-end-side second through holes 177B which are formed at predetermined intervals in the circumferential direction. The penetration directions of the rear-end-side second through holes 177B are oblique to the direction of the axial line AX. Notably, the penetration directions of the rear-end-side second through holes 177B are orthogonal to the surface of the above-mentioned diameter decreasing portion.

Similarly, the penetration directions of the first through holes 166 and 167 may be oblique to the direction of the axial line AX.

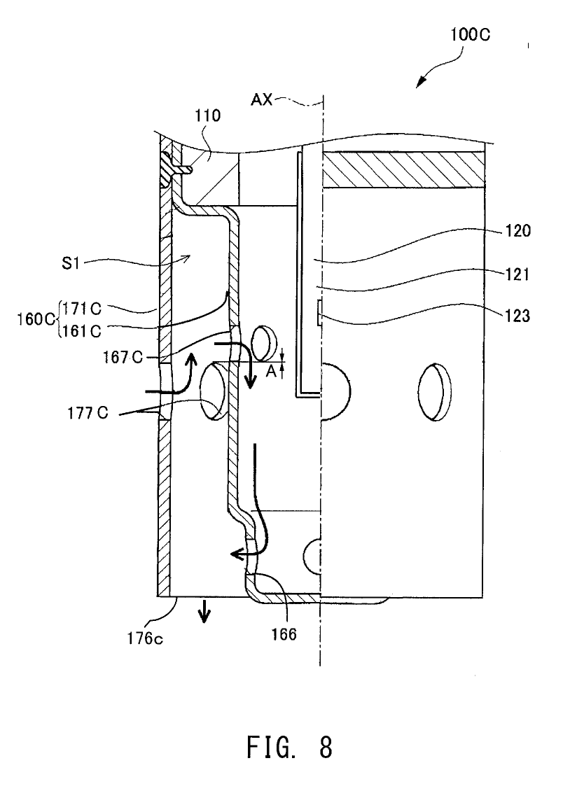

In the above-described embodiment, the first tubular portion 161 is completely accommodated in the second tubular portion 171. However, as shown in FIG. 8, a portion of the first tubular portion 161 may be exposed to the outside of the second tubular portion 171.

Notably, an intake sensor 100C of FIG. 8 is identical to the intake sensor 100 except for the shapes of a protector 160C, a second tubular portion 171C, and a first tubular portion 161C. Therefore, portions identical with those of the intake sensor 100 are denoted by the same reference numerals and their descriptions are omitted.

In the case of this protector 160C, the second tubular portion 171C has the shape of a straight circular tube which extends parallel to the direction of the axial line AX and is open at its forward end. A forward end portion of the first tubular portion 161C accommodated in the second tubular portion 171C projects (is exposed) toward the forward end side from the forward end opening of the second tubular portion 171C. In this case, the forward end opening of the second tubular portion 171C around the forward end of the first tubular portion 161C constitutes a forward-end-side second through hole 176C. On the side surface side of the protector 160C, the outer surface of the second tubular portion 171C located on the outermost side defines the “outer surface of the protector 160C.” On the forward end side of the protector 160C, the forward end edge of the second tubular portion 171C and a forward end portion of the first tubular portion 161C projecting forward from the forward end of the second tubular portion 171C define the “outer surface of the protector 160C.”

The penetration direction of the forward-end-side second through hole 176C is the axial direction of the second tubular portion 171C which forms the outer boundary of the forward-end-side second through hole 176C (in the present example, the direction of the axial line AX).

Notably, in the case of the protector 160C, the minimum distance A between the rear-end-side first through holes 167C and the rear-end-side second through holes 177C in the direction of the axial line AX is zero; namely, the forward end edges of the rear-end-side first through holes 167C are located at the same position as that of the rear end edges of the rear-end-side second through holes 177C. Namely, the expression “the tubular wall of the second tubular portion is present in the penetration directions of the first through holes 167C” encompasses the case where the circumferential edges of the rear-end-side second through holes 177C and the circumferential edges of the first through holes 167C are in point contact with a common imaginary plane parallel to the penetration directions thereof.

In the above-described embodiment, the protector 160 is a double-wall protector; i.e., has the second tubular portion 171 and the first tubular portion 161 spaced from each other in the radial direction. However, the protector 160 may be a multi-wall protector which includes three or more tubular portions spaced from one another in the radial direction. In this case, it is sufficient that any two adjacent tubular portions which include a tubular portion serving as a second tubular portion on the outer side and a tubular portion serving as a first tubular portion on the inner side are configured as described in the above embodiment.

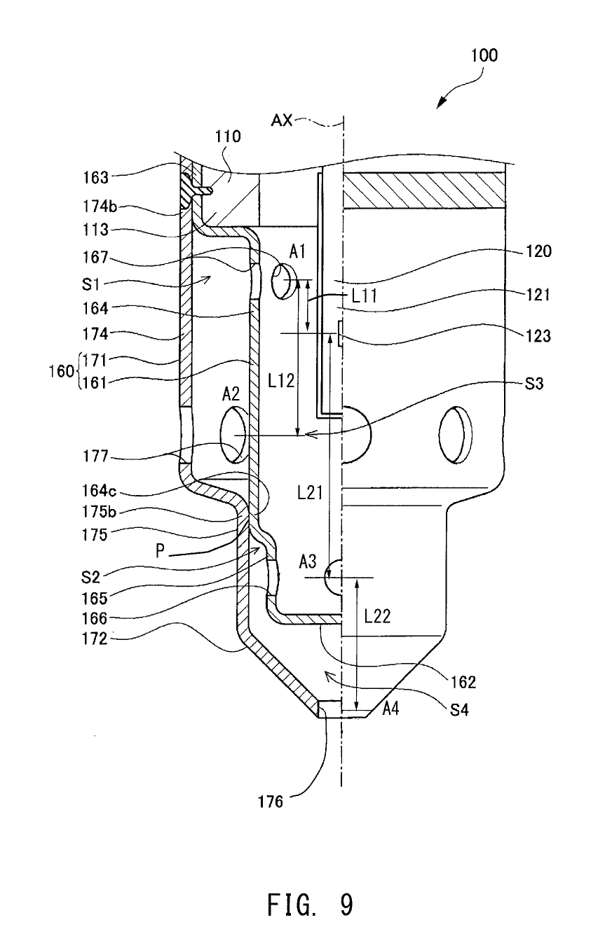

Also, as shown in FIG. 9, the protector 170 may have a structure in which both the first tubular portion 161 and the second tubular portion 171 have their bottom walls on the forward end side in the direction of the axial line AX, the first tubular portion 161 is accommodated in the second tubular portion 171, and, at a predetermined position P in the direction of the axial line AX, the tubular wall of the second tubular portion 171 and the tubular wall of the first tubular portion 161 are located close to each other with a gap V formed therebetween or are in contact with each other (as in the case of the embodiment of FIGS. 1 to 4).

Here, a space surrounded by the second tubular portion 171 and the first tubular portion 161 on the rear end side of the predetermined position P is defined as a first chamber (the first space S1), and a space surrounded by the second tubular portion 171 and the first tubular portion 161 on the forward end side of the predetermined position P is defined as a second chamber (the second space S2+the fourth space S4).

The rear-end-side first through holes 167 and the rear-end-side second through holes 177 face the first chamber, and the gas discharge holes 166 and the forward-end-side second through hole 176 which is one of the second through holes and is located forward of the rear-end-side second through holes 177 face the second chamber.

The total area of the rear-end-side first through holes 167 is represented by A1, the total area of the rear-end-side second through holes 177 is represented by A2, the total area of the gas discharge holes 166 is represented by A3, the total area of the forward-end-side second through hole 176 is represented by A4.

The sum of the shortest distance L11 between the centroids of the rear-end-side first through holes 167 and the centroid of the gas introduction portion 123 in the direction of the axial line AX and the shortest distance L12 between the centroids of the rear-end-side first through holes 167 and the centroids of the rear-end-side second through holes 177 in the direction of the axial line AX is represented by L1.

Similarly, the sum of the shortest distance L21 between the centroids of the gas discharge holes 166 and the centroid of the gas introduction portion 123 in the direction of the axial line AX and the shortest distance L22 between the centroids of the gas discharge holes 166 and the centroid of the forward-end-side second through hole 176 in the direction of the axial line AX is represented by L2.

In this case, it is preferred that a first-chamber-side flow channel coefficient Q1 (=(1/A1+1/A2)×L1) and a second-chamber-side flow channel coefficient Q2 (=(1/A3+1/A4)×L2) satisfy a relation of 0.1≦{Q1/(Q1+Q2)}≦0.9.

As described above, the space between the first tubular portion 161 and the second tubular portion 171 is divided into two spaces; i.e., the first chamber and the second chamber, in the direction of the axial line AX. Therefore, for example, in the case where a flame first blows into the first chamber from the rear-end-side first through holes 167 on the first chamber side, the pressure within the first chamber increases, and the propagation of the flame toward the rear-end-side second through holes 177 is restrained. Therefore, it is possible to prevent the flame from reaching the outside of the second tubular portion 171.

Further, the time required for the flame to pass through the first chamber and reach the outside of the second tubular portion 171 can be expressed by the product of the resistance and distance L1 of a flow channel passing through the rear-end-side first through hole 167 and the rear-end-side second through hole 177. The flow channel resistance can be expressed by the reciprocals of A1 and A2, and these holes are connected in series. Therefore, the first-chamber-side flow channel coefficient Q1 can be expressed as described above.

Similarly, the time required for the flame to pass through the second chamber and reach the outside of the second tubular portion 171 can be expressed by the above-mentioned second-chamber-side flow channel coefficient Q2.

When the values of Q1 and Q2 differ greatly, a flame becomes likely to blow from one of the first chamber and the second chamber ahead of blowing from the other chamber, and an external gas mixture becomes more likely to be ignited. Therefore, the first-chamber-side flow channel coefficient Q1 and the second-chamber-side flow channel coefficient Q2 are determined to satisfy the relation of 0.1≦{Q1/(Q1+Q2)}≦0.9.

Notably, since the length of the intake sensor in the direction of the axial line AX is sufficiently large as compared with the length in the radial direction, the growth of the flame in the radial direction is determined by the diameter of the protector 160. Therefore, only the flow channel distances L1 and L2 in the direction of the axial line AX are considered.

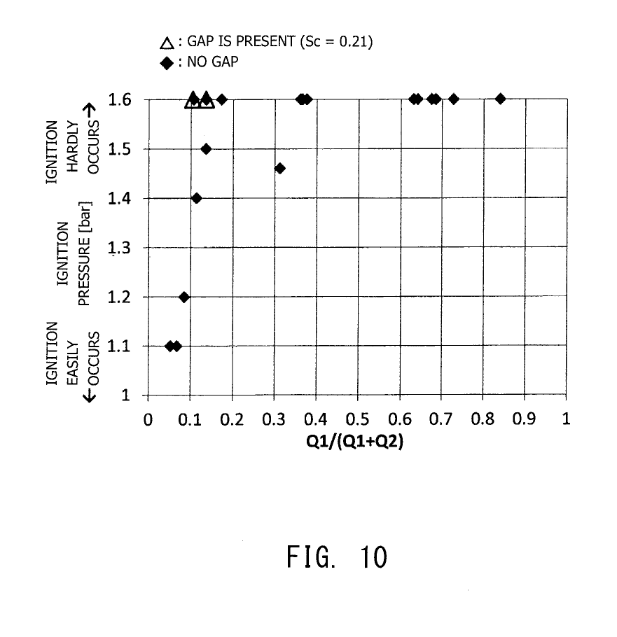

FIG. 10 shows the result of an evaluation test in which protectors 160 having different values of Q1 and Q2 were manufactured, and the one-minute continuous test was performed as described above through use of the above-mentioned model gas mixture so as to judge whether or not ignition occurred. The results show that ignition can be prevented when the relation of 0.1≦{Q1/(Q1+Q2)}≦0.9 is satisfied.

Notably, in FIG. 10, rhombic marks show the results for the case where the gap V(Sc)=0, and triangular marks show the results for the case where V(Sc)=0.21.

In a cross section which intersects the axial line AX at the predetermined position P, the area of a region surrounded by the outer edge of the first tubular portion 161 is represented by SA1, and the area of a region surrounded by the inner edge of the second tubular portion 171 is represented by SA2.

In the case where the gap V is provided between the tubular wall of the second tubular portion 171 and the tubular wall of the first tubular portion 161, an index Sc representing the size of the gap V (Sc=(SA2−SA1)/SA1) is preferably 0.3 or less.

When Sc≦0.3, the gap V produces a sufficiently large passage resistance, and the first chamber and the second chamber can be separated from each other without fail irrespective of presence of the gap V.

In the above-described embodiment, the metallic shell has a tool engagement portion and is screwed into an attachment portion. However, the metallic shell may be attached through use of a screw portion provided separately from the metallic shell, or the metallic shell may be attached to the attachment portion by means of press-fitting or the like, without using screws. Also, any other method may be used so as to fix the gas sensor element within the metallic shell.

In the embodiment, the intake sensors 100, 100B, and 100C are full-range air/fuel ratio sensors. However, the present invention can be applied to, for example, λ sensors.

The internal combustion engine to which the present invention is applied is not limited to gasoline engines, and the present invention can be applied to, for example, engines which uses CNG (natural gas) as a fuel.

### DESCRIPTION OF REFERENCE NUMERALS

100, 100B, 100C: intake sensor
110: metallic shell (housing)
120: detection element
121: detection portion
160, 160B, 160C: protector
161, 161B, 161C: first tubular portion
166, 167, 167C: first through hole
166: gas discharge hole
167, 167C: rear-end-side first through hole
171, 171B, 171C: second tubular portion
174: tubular wall (first outer wall)
175: tubular wall (second outer wall)
176, 176C, 177, 177B, 177C: second through hole
177, 177B, 177C: rear-end-side second through hole
176, 176c: forward-end-side second through hole
AX: axial line
G: gas mixture (gas to be detected)

1. An intake sensor provided in an intake system of an internal combustion engine and used for an EGR system, comprising:
a detection element including at least one cell having an oxygen-ion conductive solid electrolyte member and a pair of electrodes disposed on the solid electrolyte member, the detection element extending in a direction of an axial line and having a detection portion on a forward end side so as to detect a particular gas component contained in a mixed gas;
a heater that is configured to heat the solid electrolyte member to a target temperature;
a housing which surrounds a circumference of the detection element such that the detection portion projects from a forward end of the housing; and
a protector fixed to the housing and surrounding a circumference of the detection portion, wherein
the protector has a multi-wall structure having two or more tubular portions spaced from one another in a radial direction,
each of the tubular portions has a through hole penetrating therethrough, one of any two adjacent tubular portions, which is located on an inner side in the radial direction, is defined as a first tubular portion and the other of the two adjacent tubular portions, which is located on an outer side in the radial direction, is defined as a second tubular portion, and the second tubular portion has a tubular wall which is present in a penetration direction of a first through hole, which is the through hole of the first tubular portion,
a second through hole, which is the through hole of the second tubular portion, has an area equal to or greater than that of the first through hole, and
when the intake sensor is disposed in a model gas mixture of butane and air having an air-fuel ratio of 13, pressure of 0.11 MPa, temperature of 20° C., and flow rate of 0 m/sec, and the heater is energized to heat the solid electrolyte member to the target temperature, no combustion flame of the model gas mixture is visually recognized on the outer side of an outer surface of the protector.

2. The intake sensor according to claim 1, wherein a maximum spacing B between the second tubular portion and the first tubular portion in the radial direction is greater than 0 mm and not greater than 2.5 mm.

3. The intake sensor according to claim 1, wherein a maximum thickness t of a portion of the second tubular portion which faces the first tubular portion is in a range of 0.3 mm to 1.0 mm.

4. The intake sensor according to claim 1, wherein
the first tubular portion has a plurality of the first through holes, and one of the first through holes is a gas discharge hole formed in a forward end portion of the first tubular portion;
the second tubular portion has a plurality of the second through holes, and a rear-end-side first through hole, which is one of the first through holes but differs from the gas discharge hole, is located rearward of a rear-end-side second through hole, which is one of the second through holes and is located at the rearmost end; and
the detection portion overlaps the rear-end-side first through holes in the direction of the axial line or located forward of the rear-end-side first through holes.

5. The intake sensor according to claim 4, wherein a minimum distance A between the rear-end-side first through hole and the rear-end-side second through hole in the direction of the axial line satisfies a relation of A/B≧1 and a relation of A≦30 mm.

6. The intake sensor according to claim 1, wherein
both the first tubular portion and the second tubular portion have their bottom walls on the forward end side in the direction of the axial line, the first tubular portion is accommodated in the second tubular portion, and the tubular wall of the second tubular portion and the tubular wall of the first tubular portion are located close to each other with a gap formed therebetween, or are in contact with each other, at a predetermined position in the direction of the axial line;
the first tubular portion has a plurality of the first through holes, and one of the first through holes is a gas discharge hole formed in a forward end portion of the first tubular portion;
the second tubular portion has a plurality of the second through holes, and a rear-end-side first through hole which is one of the first through holes but differs from the gas discharge hole is disposed rearward of a rear-end-side second through hole which is one of the second through holes and is located at the rearmost end;
when a space surrounded by the second tubular portion and the first tubular portion on the rear end side of the predetermined position is defined as a first chamber, and a space surrounded by the second tubular portion and the first tubular portion on the forward end side of the predetermined position is defined as a second chamber, the rear-end-side first through hole and the rear-end-side second through hole face the first chamber, and the gas discharge hole and a forward-end-side second through hole which is one of the second through holes and is located forward of the rear-end-side second through hole face the second chamber; and
a first-chamber-side flow channel coefficient Q1 expressed by a formula of (1/A1+1/A2)×L1 and a second-chamber-side flow channel coefficient Q2 expressed by a formula of (1/A3+1/A4)×L2 satisfy a relation of 0.1≦{Q1/(Q1+Q2)}≦0.9, where A1 is a total area of the rear-end-side first through hole, A2 is a total area of the rear-end-side second through hole, A3 is a total area of the gas discharge hole, A4 is a total area of the forward-end-side second through hole, L1 is the sum of a shortest distance L11 in the direction of the axial line between the centroid of the rear-end-side first through hole and the centroid of a gas introduction portion which is provided on the detection element for introducing the gas to the detection portion and a shortest distance L12 in the direction of the axial line between the centroid of the rear-end-side first through hole and the centroid of the rear-end-side second through holes, and L2 is the sum of a shortest distance L21 in the direction of the axial line between the centroid of the gas discharge hole and the centroid of the gas introduction portion and a shortest distance L22 in the direction of the axial line between the centroid of the gas discharge hole and the centroid of the forward-end-side second through hole.

7. The intake sensor according to claim 6, wherein an index Sc representing the size of the gap and expressed by a formula of (SA2−SA1)/SA1 is 0.3 or less, where SA1 is the area of a region surrounded by an outer edge of the first tubular portion in a cross section which intersects the axial line at the predetermined position, and SA2 is the area of a region surrounded by an inner edge of the second tubular portion in the cross section.
